(19) United States
(12) Patent Application Publication
(10) Pub. No.: US 2012/0323527 A1
(43) Pub. Date: Dec. 20, 2012

(54) METHOD FOR DETERMINING A PARAMETER REPRESENTATIVE OF THE STATE OF VIGILANCE OF A VEHICLE DRIVER

(75) Inventor: Bertrand Godreau, Toulouse (FR)

(73) Assignee: CONTINENTAL AUTOMOTIVE FRANCE, Toulouse (FR)

(21) Appl. No.: 13/519,441

(22) PCT Filed: Oct. 22, 2010
(86) PCT No.: PCT/EP2010/006482

§ 371 Date: Jun. 27, 2012

(30) Foreign Application Priority Data
Dec. 28, 2009 (FR) 0906359

(51) Int. Cl. G06F 15/00; G04F 13/00

(52) U.S. Cl. 702/176

(57) ABSTRACT

A method for determining a parameter representative of the state of vigilance of a vehicle driver, on the basis of information, termed TLC values, representative of the residual time before the vehicle crosses a traffic line, includes, at each instant t0 of measurement of a TLC value, calculating an indicator parameter representing the state of vigilance PerTLC(t0) such that:

$$PerTLC ( t 0 ) = {\int }_{{α}_{M I N}}^{{α}_{M AX}} PerTLC ( W ( α ) , α ) d α$$

with:
PerTLC(W(α),α)=percentage of time during which the TLC value is below a threshold α in a time window W(α),
[αmin-αmax] determined range of values α expressed in units of time
and W(α) monotonic function.

The invention relates to a method for determining a parameter representative of the state of vigilance of a vehicle driver.

When analyzing the behavior of vehicle drivers, it has been established that the state of vigilance of the drivers could be evaluated on the basis of information (“time to lane crossing”) representative of the residual time before the vehicle crosses a traffic line, either real (conventional lines demarcated on the road), or virtual (statistically established driving lines, self-imposed by the driver).

A conventional method for interpreting this information consists in calculating indicators representative of the percentage of time for which the residual time is below a given threshold in a time window of predetermined duration. However, especially on account of the difficulties in determining the parameters necessary for the implementation thereof (value of the thresholds, size of the time windows, etc.), this process turns out to be of very relative precision and therefore of very relative reliability.

The present invention is aimed at alleviating this drawback and its main objective is to provide a reliable and precise method for determining a parameter representative of the state of vigilance of a driver on the basis of information representative of the residual time before the vehicle crosses a traffic line.

For this purpose, the invention is aimed at a method for determining a parameter representative of the state of vigilance of a vehicle driver, on the basis of information, termed TLC values, representative of the residual time before the vehicle crosses a traffic line, characterized in that it consists, at each instant t0 of measurement of a TLC value, in calculating an indicator parameter representing the state of vigilance PerTLC(t0) such that:

$$PerTLC ( t 0 ) = {\int }_{{α}_{M I N}}^{{α}_{M AX}} PerTLC ( W ( α ) , α ) d α$$

with:
PerTLC(W(α),α)=percentage of time during which the TLC value is below a threshold α in a time window W(α),
[αmin-αmax] determined range of a values expressed in units of time,
and W(α) monotonic function.

The method according to the invention is therefore based on the vigilance indicator PerTLC(t0) measuring the percentage of time spent under a threshold α during a time window, and exhibits the particular feature of doing a continuous sum (integral) of the values of PerTLC(t0) for thresholds varying between two extreme values αmin, αmax, with each of which is associated a window W(α).

Such a method thus allows direct use of the TLC values with a view to determining a parameter representative of the state of vigilance of a vehicle driver, without requiring a definition of the thresholds α nor of the size of the windows W(α).

Such a method thus turns out to lead, in a reliable and precise manner, to the determination of a parameter that can be utilized directly with a view to judging the state of vigilance of a driver.

With a view to the implementation of this method, and in an advantageous manner according to the invention, the range [αmin-αmax] is initially fixed at a range [0-10], and the values αmin and αmax are thereafter determined by a statistical approach adapted so as to ensure allowance for inter-driver and intra-driver behavior differences.

Also with a view to the implementation of this method, and in an advantageous manner according to the invention, the function W(α) is a linear function, and advantageously an increasing linear function.

Moreover, a predetermined weight P(α) is advantageously assigned to each threshold value α, so as to calculate a parameter PerTLC(t0) such that:

$$PerTLC ( t 0 ) = {\int }_{{α}_{M I N}}^{{α}_{M AX}} P ( α ) PerTLC ( W ( α ) , α ) d α$$

These weights P(α) are intended, for example through statistical approaches, to make it possible to ascribe a predominant value to the most “expressive” thresholds and are in particular advantageously adapted so as to exhibit a significant value for the low threshold values (below one second).

Together, these data lead, in an advantageous manner according to the invention, to the calculation, at each instant t0, of a parameter PerTLC(t0) such that:

$$PerTLC ( t 0 ) = {\sum }_{t = t 0 - {W}_{M AX}}^{t = t 0} {\int }_{{α}_{M I N}}^{{α}_{M AX}} P ( α ) \frac{H ( t - ( t 0 - W ( α ) ) ) * H ( α - TLC ( t ) )}{W ( α )} d α$$

with H(x)=1 if x>0 and H(x)=0 if x≦0.

The method according to the invention will be better understood on reading the detailed description which follows with reference to the appended drawings which represent:

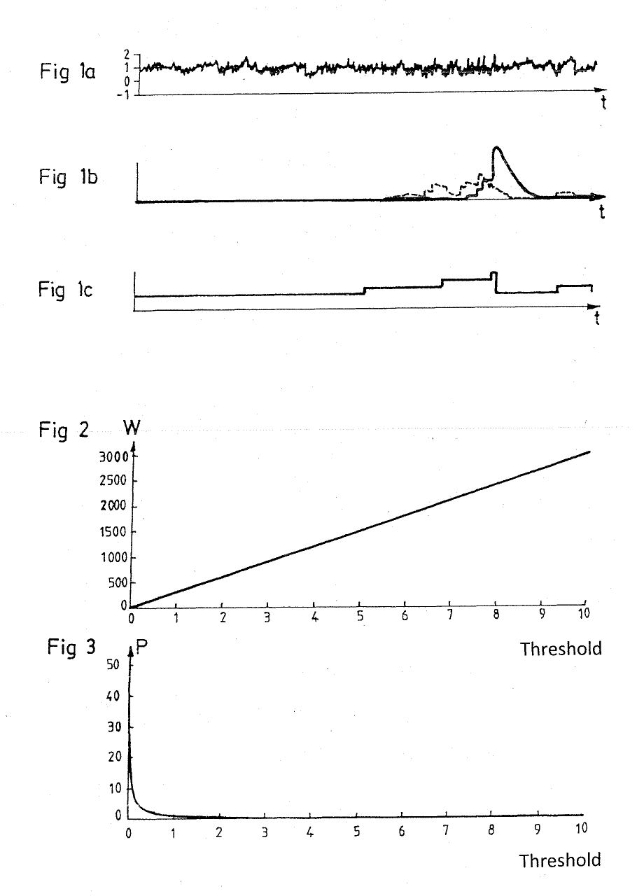

FIG. 1a, a curve representative of the variations of the lateral position of a vehicle,

FIG. 1b, the corresponding curves of the variations of the two values PerTLC (which relate to the central traffic line and to the lateral traffic line) determined in accordance with the method according to the invention,

FIG. 1c, by way of comparison, the corresponding curve established by an expert assessment,

FIG. 2, a curve representative of the function W(α) on which W is expressed in tenths of a second,

and FIG. 3, a curve representative of the function P(α).

The method according to the invention, and described hereinbelow with reference to the appended drawings, consists of a method for determining a parameter representative of the state of vigilance of a vehicle driver, on the basis of information, termed TLC values, representative of the residual time before the vehicle crosses a traffic line.

This method consists, generally, in calculating, at each instant t0 of measurement of a TLC value, a parameter PerTLC (t0) such that:

$$PerTLC ( t 0 ) = {\sum }_{t = t 0 - {W}_{M AX}}^{t = t 0} {\int }_{{α}_{M I N}}^{{α}_{M AX}} P ( α ) \frac{H ( t - ( t 0 - W ( α ) ) ) * H ( α - TLC ( t ) )}{W ( α )} d α$$

with:

W(α) time window of value determined on the basis of the curve of FIG. 2,

P(α) weight of value determined on the basis of the curve of FIG. 3,

H(x)=1 if x>0 and H(x)=0 if x≦0.

Furthermore, prior to launching this method, the range [αmin-αmax] is initially fixed at [0-10], and the values αmin and αmax are thereafter determined by a statistical approach adapted so as to ensure allowance for inter-driver and intra-driver behavior differences.

Examination of the curves of FIGS. 1b and 1c reveals that this method leads to results similar to those obtained with an expert assessment, in particular as regards the “spikes” representative of a consequent decline in vigilance.

1. A method for determining a parameter representative of the state of vigilance of a vehicle driver, on the basis of information, termed TLC values, representative of the residual time before the vehicle crosses a traffic line, which comprises, at each instant t0 of measurement of a TLC value, calculating an indicator parameter representing the state of vigilance PerTLC(t0) such that:
$$PerTLC ( t 0 ) = {{\int }_{{α}_{MIN}}}^{{α}_{MAX}} PerTLC ( W ( α ) , α ) d α$$
with:
PerTLC(W(α),α)=percentage of time during which the TLC value is below a threshold α in a time window W(α),
[αmin-αmax] determined range of values α expressed in units of time,
and W(α) monotonic function.

2. The method as claimed in claim 1, wherein the range [αmin-αmax] is initially fixed at a range [0-10], and the values αmin and αmax are thereafter determined by a statistical approach adapted so as to ensure allowance for inter-driver and intra-driver behavior differences.

3. The method as claimed in claim 1, characterized in that the function W(α) is a linear function.

4. The method as claimed in claim 3, wherein the function W(α) is an increasing linear function.

5. The method as claimed in claim 1, wherein a predetermined weight P(α) is assigned to each threshold value α, so as to calculate a parameter PerTLC(t0) such that:
$$PerTLC ( t 0 ) = {{\int }_{{α}_{MIN}}}^{{α}_{MAX}} P ( α ) PerTLC ( W ( α ) , α ) d α$$

6. The method as claimed in claim 5, wherein at each instant t0, a parameter PerTLC(t0) is calculated such that:
$$PerTLC ( t 0 ) = {\sum }_{t = t 0 - {W}_{MAX}}^{t = t 0} {{\int }_{{α}_{MIN}}}^{{α}_{MAX}} P ( α ) \frac{H ( t - ( t 0 - W ( α ) ) ) * H ( α - TLC ( t ) )}{W ( α )} d α$$
with H(x)=1 if x>0 and H(x)=0 if x≦0.

7. The method as claimed in claim 2, characterized in that the function W(α) is a linear function.

8. The method as claimed in claim 2 a predetermined weight P(α) is assigned to each threshold value α, so as to calculate a parameter PerTLC(t0) such that:
$$PerTLC ( t 0 ) = {{\int }_{{α}_{MIN}}}^{{α}_{MAX}} P ( α ) PerTLC ( W ( α ) , α ) d α$$

9. The method as claimed in claim 3 a predetermined weight P(α) is assigned to each threshold value α, so as to calculate a parameter PerTLC(t0) such that:
$$PerTLC ( t 0 ) = {{\int }_{{α}_{MIN}}}^{{α}_{MAX}} P ( α ) PerTLC ( W ( α ) , α ) d α$$

10. The method as claimed in claim 4 a predetermined weight P(α) is assigned to each threshold value α, so as to calculate a parameter PerTLC(t0) such that:
$$PerTLC ( t 0 ) = {{\int }_{{α}_{MIN}}}^{{α}_{MAX}} P ( α ) PerTLC ( W ( α ) , α ) d α$$

11. The method as claimed in claim 8, at each instant t0, a parameter PerTLC(t0) is calculated such that:
$$PerTLC ( t 0 ) = {\sum }_{t = t 0 - {W}_{MAX}}^{t = t 0} {{\int }_{{α}_{MIN}}}^{{α}_{MAX}} P ( α ) \frac{H ( t - ( t 0 - W ( α ) ) ) * H ( α - TLC ( t ) )}{W ( α )} d α$$
with H(x)=1 if x>0 and H(x)=0 if x≦0.

12. The method as claimed in claim 9, at each instant t0, a parameter PerTLC(t0) is calculated such that:
$$PerTLC ( t 0 ) = {\sum }_{t = t 0 - {W}_{MAX}}^{t = t 0} {{\int }_{{α}_{MIN}}}^{{α}_{MAX}} P ( α ) \frac{H ( t - ( t 0 - W ( α ) ) ) * H ( α - TLC ( t ) )}{W ( α )} d α$$
with H(x)=1 if x>0 and H(x)=0 if x≦0.

13. The method as claimed in claim 10, wherein at each instant t0, a parameter PerTLC(t0) is calculated such that:
$$PerTLC ( t 0 ) = {\sum }_{t = t 0 - {W}_{MAX}}^{t = t 0} {{\int }_{{α}_{MIN}}}^{{α}_{MAX}} P ( α ) \frac{H ( t - ( t 0 - W ( α ) ) ) * H ( α - TLC ( t ) )}{W ( α )} d α$$
with H(x)=1 if x>0 and H(x)=0 if x≦0.
